(19) United States
(12) Patent Application Publication
(10) Pub. No.: US 2011/0078561 A1
(43) Pub. Date: Mar. 31, 2011

(54) METHOD AND SYSTEM OF FORMATTING TEXT IN AN ELECTRONIC DOCUMENT TO INCREASE READING SPEED

(76) Inventor: Daniel Herzner, White Plains, NY (US)

(21) Appl. No.: 12/884,393

(22) Filed: Sep. 17, 2010

Related U.S. Application Data
(60) Provisional application No. 61/246,256, filed on Sep. 28, 2009.

(51) Int. Cl. G06F 17/24

(52) U.S. Cl. 715/256

(57) ABSTRACT

In one embodiment, a method for formatting text that is made up of a plurality of words and is part of a document comprising the steps of: receiving text that is presented in a first format in which each line of a paragraph is read from left-to-right; and processing and converting the text in the first format to a second text format. Wherein, in the second text format, text in odd numbered lines of each paragraph is presented in a right reading format in that the text is read from left-to-right, wherein the text is defined by a plurality of words; and text in even numbered lines of the paragraph is presented in a backwards format such that a line of words that define the text is read right-to-left; however, each individual word in the even numbered line is read left-to-right.

### CROSS-REFERENCE TO RELATED APPLICATIONS

The present application claims the benefit of U.S. patent application Ser. No. 61/246,256, filed Sep. 28, 2009 which is hereby incorporated by reference in its entirety.

### TECHNICAL FIELD

The present application relates to the creation of electronic documentation and in particular, relates to a method of presenting text in an electronic document that improves reading speed.

### BACKGROUND

Traditional publishing methods dictate that each individual line of reading material printed in the English language is read from left to right. When an individual completes the reading of a row of words they must drag their eye back across the page from right to left to begin reading the next row. The wider the page, the longer the sentence, the more difficult and tiresome traditional reading becomes. This is especially true when reading documents rendered on a computer screen. A visual representation of this conventional reading style is illustrated in FIG. 1.

Many speed reading instructors and courses encourage “backwards reading” as one way of accelerating one's reading speed. They reason that reading backwards can shave, on average, a few seconds off of your reading time for each row of words. This time saved can add up significantly when considering the number of rows of words on a single page and the number of pages in a single book. A visual representation of the “backwards reading” technique is illustrated in FIG. 2.

Reading backwards does save a significant amount of time which translates into significantly faster reading. However, there is one colossal drawback to backwards reading; namely, it is extremely confusing and difficult and most people are incapable of doing it efficiently. And, the longer a row of words, the more challenging this becomes.

As a result of the above deficiencies, there is a need for an improved method of increasing reading speed especially for documents presented in electronic form.

### SUMMARY

The present invention is directed to a method of presenting text in an electronic document (Easy Reader Publishing Model) and thus, the method is for use in the creation of electronic documentation. Specifically, the method according to the present invention is capable of improving anybody's reading speed by up to 100% or more regardless of current reading skill. This improvement in reading speed is attained almost instantly without the need for expensive, time consuming courses or study material. The method of the present invention can be implemented with astonishing results. The effectiveness of the present invention does not lie in the scholastic aptitude of the individual but rather in the formatting of how reading material is published or rendered. Thus, the present invention is directed to a formatting technique that results in the presentation of the text in a different format compared to conventional left-to-right presentation and one that permits reading speeds to increase. Therefore, improved reading speed of electronic documents is available to all regardless of economic circumstances, time constraints or current reading skills.

The necessity and frustration of purchasing expensive courses and spending hour upon hour “practicing” speed reading techniques is obviated under the method of presenting text according to the present invention (Easy Read Publishing Model). What's most exciting about the present invention is that people need to only slightly tweak the way they've been trained to read all their lives. All that is required to improve reading speed, and interest in reading itself, is for someone to open an electronic document that has been published and formatted using the method according to the present invention.

In one embodiment, a method for formatting text that is made up of a plurality of words and is part of a document comprising the steps of: receiving text that is presented in a first format in which each line of a paragraph is read from left-to-right; and processing and converting the text in the first format to a second text format. Wherein, in the second text format, text in odd numbered lines of each paragraph is presented in a right reading format in that the text is read from left-to-right, wherein the text is defined by a plurality of words; and text in even numbered lines of the paragraph is presented in a backwards format such that a line of words that define the text is read right-to-left; however, each individual word in the even numbered line is read left-to-right.

The key to the success of the present method is that it places negligible onus on the individual with the majority on the way in which reading material is published.

### BRIEF DESCRIPTION OF THE DRAWING FIGURES

FIG. 1 is a visual representation of a conventional left-to-right publishing method where words in each line are read from left-to-right;

FIG. 2 is a visual representation of a conventional “backwards reading” technique;

FIG. 3 is a visual representation of the presentation of text according to the method of the present invention;

FIG. 4 is a visual representation of two consecutive paragraphs formatted in accordance with the method of the present invention;

FIG. 5 is a visual representation of a paragraph formatted in accordance with the method of the present invention and including a page break therein;

FIG. 6 is a block diagram of a system for converting traditionally formatted text into the format/publishing model of the present invention; and

FIG. 7 is visual representation of the presentation of text according to the method of present invention.

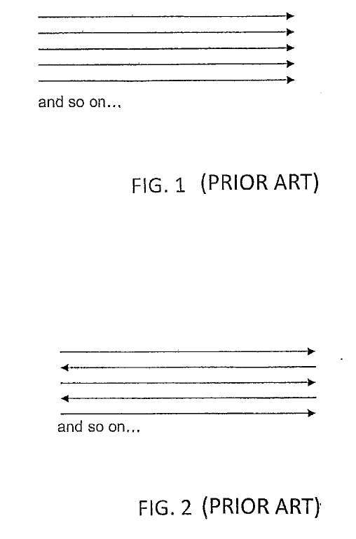

### DETAILED DESCRIPTION OF THE PRESENT INVENTION

In accordance with the present invention, a method of formatting text, especially in an electronic document, is presented. The publishing method of the present invention takes advantage of the speed gained in reading a row of text backwards and blends it with the ability to actually understand what is being read. Therefore, the time that can be gained in reading every other row of text backwards can be realized in a sensible, pragmatic and useful way. This can be made possible by using the formatting and publishing technique of the present invention (Easy Reader Publishing Model) which prints every other row of text backwards making reading the backwards row just as easy as reading a row left to right.

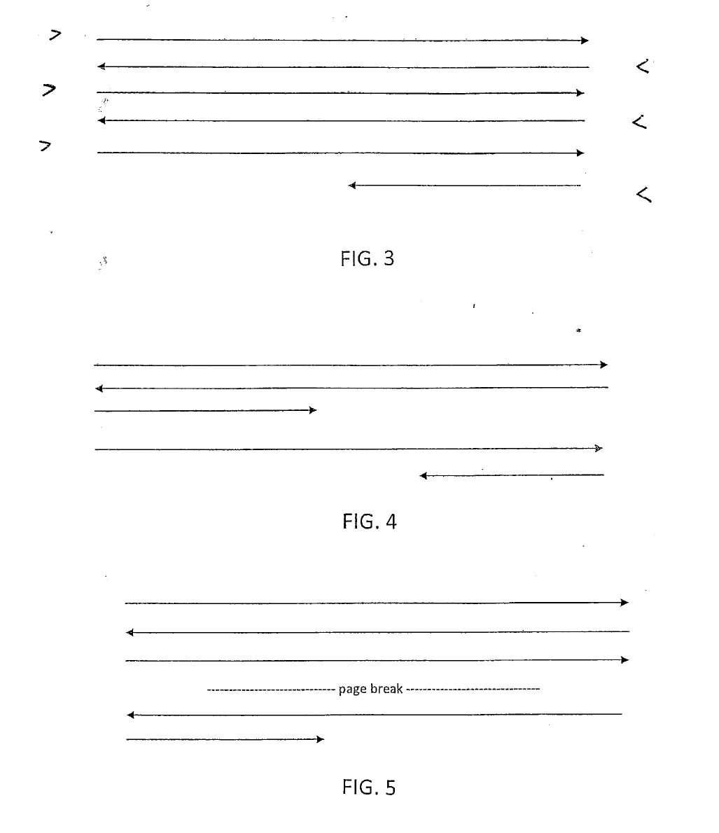

FIG. 3 is a visual representation of the formatting/presentation method according to the present invention. Each line in FIG. 3 indicates the direction of a line of text within a paragraph published using the formatting method of the present invention. Every odd numbered line is rendered right reading (read from left-to-right) and every even numbered line is rendered in the formatting of the present invention where the text is read from right-to-left. The last line is rendered backwards (read right-to-left) and is right justified.

FIG. 4 represents two consecutive paragraphs in a document published using the formatting published in accordance with the present invention. Even though the final line of the first paragraph is rendered right reading (from left-to-right), the first line of the second paragraph is also rendered right reading (from left-to-right).

FIG. 5 represents a paragraph within a document published under the formatting technique of the present invention and where the paragraph has been broken up by a page break. The first line of the new page, which is the fourth line of a complete paragraph, is rendered backwards (from right to left).

### EXAMPLE

So far you've been reading this document in the traditional fashion and you've had little choice since it was published to be read that way. Now, read the following three paragraphs taken from Robert Kiyosaki's book entitled “Before You Quit Your Job”. These three paragraphs have been rendered using the formatting technique of the present invention (Easy Reader Publishing Model). This excerpt was chosen because it contains a variety of elements frequently found throughout published material (commas, colons, parenthesis, etc).:
When entrepreneurs make a mistake, they typically do not fixate on the consequences mistake the making that concerned particularly not are typically They .mistake the of might make them look bad. The true entrepreneur focuses instead on learning form the avoid you do How ?mistake the form resulting problems any solve you do How .mistake making the mistake in the future? How do you minimize the adverse consequences of the on capitalize to way a there Is ?future the in again occur does it if mistake the mistake and turn it into an advantage?
How do you capitalize on a mistake? I like to think in terms of turning problems into opp- or avoid to how—it for solution a with up come and problem a identify You .ortunities minimize the consequences of the mistake. That solution may well be a valuable asset be can which or built be can business a which around (property intellectual called often) used as a tool to grow your existing business. Of course, you would want to put legal greatest the to solution that to rights exclusive have you that so place in protection extent possible.
For example, let's take a trip back through time and assume that you were in the way hard the out found You .radios transistor first the of one developing of process that if you made a mistake in the way that you connected the battery to the circuit point that At .smoke in up go to tendency a had transistors the, (polarity the reversed) in time, transistors were very expensive, and it was a costly mistake. But you learned a with plug a :solution a with up come and—problem a identify You .mistake the from key that prevents it from being inserted the wrong way. Assume that you are able to could you that think you Do .problem the to solution your on protection patent obtain build a business around the solution to that mistake?

The above paragraphs represent the formatting/publishing method of the present invention.

In different embodiments, the formatting/publishing method of the present invention can have the following characteristics: (1) Every odd numbered lines of a paragraph is always rendered right reading (i.e., read from left-to-right); (2) Every even numbered line of a paragraph is always rendered backwards with the words themselves right reading (i.e., each word reads left-to-right with the line of words being read right-to-left)(this format is known herein as the Easy Reader Format); (3) All paragraphs begin with a right reading line regardless of whether or not the final line of the previous paragraph was right reading; (4) If the first line of a new page happens to be an even numbered line from a paragraph initiated on the previous page, that line will be rendered in the Easy Reader Format; (5) Single sentence paragraphs which do not extend beyond a single line are always rendered right reading; (6) if the final line of a paragraph is even numbered (rendered in Easy Reader Format) then just that line—not the entire paragraph—will be right justified; (7) paragraphs in books, documents, and other papers where the Easy Reader model is applied are to be fully justified; (8) all punctuation where required will always be rendered right reading when appearing in a line rendered in a backwards line. For example, if the line “What is your name?” is rendered backwards, it would appears as “?name your is What” with the question mark being right reading; (9) A single word in a backwards line made up of two separate words can be rendered right reading. For example, the phrase “look at the hoi polloi” rendered in a backwards line would be published as “hoi polloi the at look”. Or, if the end user prefers, the two separate words making up the whole word can be rendered backwards as in “polloi hoi the at look”; (10) A single word in a backwards line made up of two words held together with a hyphen can be rendered right reading depending upon the end user's preference. For example, the phrase “you must opt-in” rendered in a backwards line would be published as “opt-in must you”. Or, if the end user prefers, the prefers, the hyphenated word can be rendered backwards as in “in-opt must you”; (11) If a line rendered backwards contains a phrase in parenthesis, the opening parenthesis will be a right parenthesis and the closing parenthesis will be a left parenthesis. For example, the line:

I love chocolate ice cream (just in case you were wondering) with sprinkles.

would be rendered in Easy Reader Format as:

.sprinkles with (wondering were you case in just) ice cream chocolate love I; (12) If a mid sentence phrase enclosed in parenthesis begins with a right reading line and concludes in the following line rendered backwards, the opening parenthesis will be a left parenthesis and the closing parenthesis will be a left parenthesis; (13) Numbers rendered in Easy Reader Format are always right reading with right reading placement of dollar sign and decimal point. For example, the line:

I made $10,000.00 last month.

would be rendered in Easy Reader Format as:

.month last $10,000.00 made I;

(it will be appreciated that fractions are also presented in the same right reading format; (14) the formatting model of the present invention can be specified to have the first line of every new paragraph rendered in a traditionally published format; read left to right, words right reading; (15) the format/publishing model can be specified to have the first line of every new paragraph rendered backwards; read right to left, depending upon how the final line of the previous paragraph was rendered. If the final line of a previous paragraph was rendered in a traditionally published format; read left to right, then the first line of the following paragraph can be rendered backwards. This format is known herein as the continual flow format; (16) the first line of each new paragraph is to be rendered either traditionally or in continual flow format depending upon the end user's preference; (17) if the end user's preference is for the first line of each new paragraph to be rendered in a traditional format then every odd numbered line of every paragraph will always be rendered in a traditionally published format; read left to right. Therefore, under this preference, every even numbered line of every paragraph will always be rendered backwards; (18) if the end user's preference is for the first line of each new paragraph to be rendered in continual flow format then whether or not odd or even numbered lines within a paragraph are rendered traditionally or backwards will have no bearing; (19) the first line of the first paragraph of every new chapter, section, sub-section, introduction, epilogue, appendix or the like is to be rendered in a traditionally published format; read left to right; (20) if the first line of a new page is a continuation of a paragraph from the previous page, the line will be rendered in a traditional format or in backwards format depending upon how the last line of the paragraph was rendered on the previous page. Therefore, the zigzag reading flow will not be broken; (21) single sentence paragraphs which do not extend beyond a single line can be rendered in a traditional left to right format or in a backwards format depending upon whether or not the end user's preference is for a continual flow format; (22) if the final line of a paragraph is rendered backwards then that line, NOT the entire paragraph, is to be justified to the right; (23) paragraphs in the formatting/publishing model can be fully justified or left justified depending upon the end user's preference; (24) words in backwards lines can be right reading or written backwards depending upon the end user's preference. For example, the phrase “I really think that this is it” can be rendered backwards as “it is this that think really I” or the same phrase can be rendered as “ti si siht taht kniht yllaer I”.

FIG. 3 shows a visual indicator that can be used to indicate the direction that a particular line is flowing. For example, in a margin section of the document, a visual indicator, such as an arrow, shows which direction a line is flowing. In FIG. 3, the odd lines that read from left-to-right can have an arrow (>) that is disposed within the left margin, while the even lines that read from right-to-left can have an arrow (<) that is disposed within the right margin.

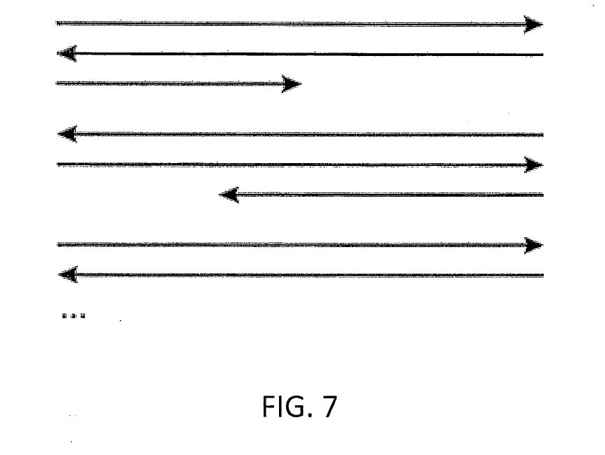

FIG. 7 shows a continual flow format option that can be selected by the user.

The present invention thus has particular utility in presenting documentation, such as books, in electronic form and in a manner that allows the reader to dramatically increase his/her reading speed.

In another aspect of the invention, the user can select whether words in backwards sentences can be printed right reading or they can be printed backwards depending upon the user's preferences.

Every first line of a paragraph can be rendered in a traditionally published format (read from left to right) or it can be rendered backwards (read from right to left) to continue the zigzag reading flow depending upon the end user's preference. In either case, the first line of the first paragraph of every new chapter, section, sub-section, introduction, epilogue, appendix and the like is to be rendered in a traditionally published format: read left to right, words right reading.

If the end user's preference is to have every first line of every paragraph is to have every line of every paragraph throughout the entire text rendered in a right reading format, then every odd numbered line in a paragraph will always be rendered from left to right and every even numbered line is always rendered backwards (read from right to left). If, however, it is the end user's preference to maintain the zigzag flow of reading then odd and even numbered lines within a paragraph and whether or not they are rendered right reading or backwards will have no bearing.

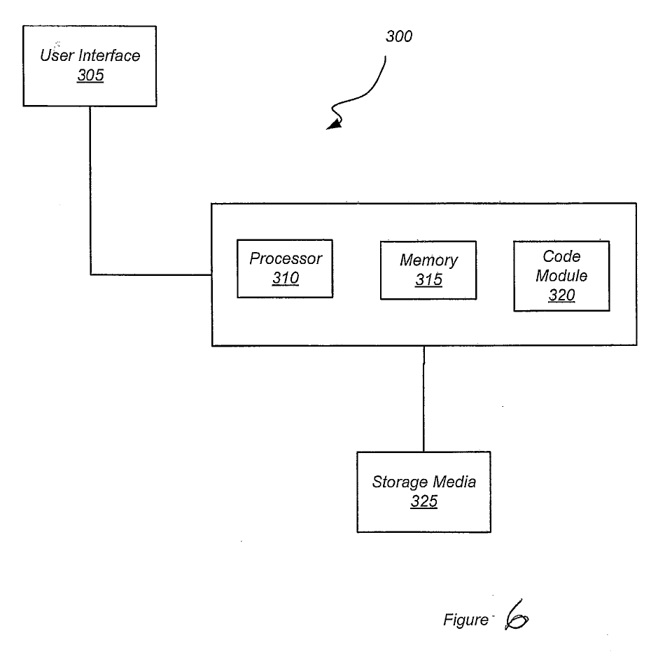

In yet another embodiment of the present invention shown in FIG. 6, a method and system for converting normal (traditionally) formatted text into the format described herein. In other words, another aspect of the invention is a computer program (software) that is configured to convert traditional left-to-right formatted text into the Easy Reader Format described herein.

In accordance with a broad aspect of the invention, embodiments are described of a computer-implemented system and a method for formatting text in an electronic document to increase reading speed. The system 300 includes a user interface 305, a processor 310, and a memory 315. The system 300 comprises machines of conventional construction such as a notebook computer, a laptop computer, and a desktop computer or other type of computer system. Although system 300 is represented herein as a standalone system, it is not limited to such, but instead can be coupled to other computer systems via a network (not shown).

The system 300 can be communicatively coupled to a distributed computer system such as the Internet. Communications comprise conventional, bidirectional transmission of information between the system, and other computers.

The memory 315 stores data and instructions from the code modules that are executed by the processor. Implementation of the memory can be by any conventional storage media 325 such as a random access memory, a magnetic tape, an optical storage media, a compact disc, or a floppy disc. Alternatively, the memory can be a random access memory, a read only memory, or other type of electronic storage. The memory, at least in part, can be located on a remote storage system.

The code module 320 includes instructions for controlling processor 310 to execute the rules. The code module may be implemented as a single module or as a plurality of modules that operate in cooperation with one another. The code module is contemplated as representing a software embodiment of the method described hereinabove. The code module 320 comprises of set of rules for formatting a paragraph in the manner described herein. The rules described herein are either default rules or user defined rules.

The user interface 305 includes an input device, such as a keyboard, touch screen, tablet, or speech recognition subsystem, for enabling a user to communicate information and command selections to processor 310. The user interface 305 also includes an output device such as a display or a printer. In the case of a touch screen, the input and output functions are provided by the same structure. A cursor control such as a mouse, track-ball, or joy stick, allows the user to manipulate a cursor on the display for communicating additional information and command selections to processor 310.

While code module 320 is indicated as already loaded into memory 315, it may be configured on a storage media 325 for subsequent loading into memory 315. The storage media 325 can be any conventional storage media such as a magnetic tape, an optical storage media, a compact disc, or a floppy disc. Alternatively, storage media 325 can be a random access memory, or other type of electronic storage, located on a remote storage system.

Through the user interface 305, text in the form of one or more paragraphs is inputted for the reformatting of the paragraph in the manner described herein. The initially inputted text is in traditional form, that is, it is read from left-to-right. The code module 320 includes a set of rules that can be used for a specific paragraph (that is observed in the document). Having determined a rule, the processor 310 calculates number of lines in the paragraph to scan an odd line and an even line for formatting a word in the paragraph. Each word can be stored in the memory 315 for further reference.

The processor 310 scans the paragraph with each word in the first line from left to right, till it reaches the last word of the first line. The processor then scans the last word of the second line and keeps scanning the words from right to left till it reaches to the first word in the second line. Therefore, scanning the words in each line of the paragraph is performed in a zig-zag manner. The processor continues to scan each line of the paragraph observing the rules described herein and reformatting the lines and words according to the stored rules. The output from the scan can be stored in the memory 315 or the storage media 325 and displayed in the user interface 305.

Alternatively, the processor 310 can act to determine which words are located in the even numbered lines based on determining where the odd lines begin and end. As a result, once the words of each even line are determined, the processor 310 can act to reformat these words into the format of the present invention. For example, the first word in the second line of traditional text is transformed into being the last word in the second line of the reformatted text; however, as described herein, the word itself is read left-to-right. This processing and conversion is done for all words in the second line of traditional text.

It will be appreciated that the processor can act on the traditional text using other processing and conversion techniques so long as the initial starting point is traditional text that is inputted for conversion and by action of the processor or the like, the text is converted according to the rules described herein and formatted into the format described herein (Easy Reader Format).

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions can be loaded onto one or more general-purpose computers, special purpose computers, or other programmable data processing translator to produce machines, such that the instructions, which execute on the computers or other programmable data processing translator create means for implementing the functions specified in the block or blocks. Such computer program instructions can also be stored in a computer-readable memory that can direct a computer or other programmable data processing apparatus to function in a particular manner, such that the instructions stored in the computer-readable memory produce an article of manufacture including instruction means that implement the function specified in the block or blocks. Furthermore, such computer program instructions can be made available for download and/or downloaded over a communication network.

What is claimed is:

1. A method for formatting text that is made up of a plurality of words and is part of a document comprising the steps of:
receiving text that is presented in a first format in which each line of a paragraph is read from left-to-right; and
processing and converting the text in the first format to a second text format, wherein text in odd numbered lines of each paragraph is presented in a right reading format in that the text is read from left-to-right, wherein the text is defined by a plurality of words; and text in even numbered lines of the paragraph is presented in a backwards format such that a line of words that define the text is read right-to-left; however, each individual word in the even numbered line is read left-to-right.

2. The method of claim 1, wherein the step of receiving text comprises inputting text in the first format using a user interface.

3. The method of claim 1, wherein the paragraph includes at least two lines and the processor scans the paragraph with each word in the first line from left to right, till it reaches the last word of the first line, wherein the processor then scans the last word of the second line and keeps scanning the words from right to left till it reaches to the first word in the second line, whereby the scanning of the words in each line of the paragraph is performed in a zig-zag manner.

4. The method of claim 1, further including the step of printing the text in second text format on a tangible medium.

5. The method of claim 4, wherein the tangible medium comprises a book.

6. The method of claim 1, wherein the steps are performed by a computer.
